(19) United States
(12) Patent Application Publication
(10) Pub. No.: US 2025/0203608 A1
(43) Pub. Date: Jun. 19, 2025

(54) INTER-CARRIER ASSOCIATION CONFIGURATION AND ASSOCIATION SCHEDULING

(71) Applicant: ZTE CORPORATION, Shenzhen (CN)

(72) Inventors: Feng XIE, Shenzhen (CN); Fei WANG, Shenzhen (CN); Hanchao LIU, Shenzhen (CN); Yan XUE, Shenzhen (CN)

(21) Appl. No.: 18/843,543

(22) PCT Filed: Mar. 10, 2022
(86) PCT No.: PCT/CN2022/080058

§ 371 Date: Sep. 3, 2024

(51) Int. Cl. H04W 72/1268; H04W 72/0446; H04W 72/0453; H04W 72/11

(52) U.S. Cl. CPC H04W 72/1268; H04W 72/0446; H04W 72/0453; H04W 72/11

(57) ABSTRACT

Systems, apparatus and method for wireless communication are described. One example method includes receiving, by a wireless device, a radio configuration indicating M resource sets, wherein each of the M resource sets corresponds to N associated resources, wherein Mis a positive integer, wherein N is an integer greater than 1, wherein the N associated resources include a reference resource, receiving, after receiving the radio configuration, a scheduling message, wherein a scheduling information for each given reference resource included in the scheduling message applies to remaining resources in a corresponding resource set that includes the given reference resource, and operating the wireless device according to the scheduling message.

### TECHNICAL FIELD

This document is directed generally to wireless communications.

### BACKGROUND

Wireless communication technologies are moving the world toward an increasingly connected and networked society. The rapid growth of wireless communications and advances in technology has led to greater demand for capacity and connectivity. Other aspects, such as energy consumption, device cost, spectral efficiency, and latency are also important to meeting the needs of various communication scenarios. In comparison with the existing wireless networks, next generation systems and wireless communication techniques will provide support for an increased number of users and devices.

### SUMMARY

This document relates to methods, systems, and devices for transmitting configuration information in mobile communication technology.

In one aspect, a method of wireless communication is disclosed. The method includes receiving, by a wireless device, a radio configuration indicating M resource sets, wherein each of the M resource sets corresponds to N associated resources, wherein M is a positive integer, wherein N is an integer greater than 1, wherein the N associated resources include a reference resource, receiving, after receiving the radio configuration, a scheduling message, wherein a scheduling information for each given reference resource included in the scheduling message applies to remaining resources in a corresponding resource set that includes the given reference resource, and operating the wireless device according to the scheduling message.

In another aspect, another method of wireless communication is disclosed. The method includes transmitting, by a network device to a wireless device, a radio configuration indicating M resource sets, wherein each of the M resource sets corresponds to N associated resources, wherein M is a positive integer, wherein N is an integer greater than 1, wherein the N associated resources include a reference resource, transmitting, after the radio configuration is transmitted, a scheduling message, wherein a scheduling information for each given reference resource included in the scheduling message applies to remaining resources in a corresponding resource set that includes the given reference resource, and operating the network device according to the scheduling message.

In another aspect, a wireless communication apparatus that is configured or operable to perform the above-described methods is disclosed. The apparatus may include a processor.

In another aspect, a computer-readable medium is disclosed. The computer-readable medium stores processor-executable code that, upon execution, causes a processor to implement a method described in the present document.

The above and other aspects and their implementations are described in greater detail in the drawings, the descriptions, and the claims.

### BRIEF DESCRIPTION OF THE DRAWINGS

FIG. 1 shows an example schematic diagram of the resource allocation results of two associated resources which are carriers.

FIGS. 2A and 2B show examples of associated resources.

FIGS. 3A and 3B depict examples of associated resources.

FIGS. 4A and 4B shows examples of associated resources.

FIG. 5 shows a flowchart of an example method of wireless communication.

FIG. 6A shows an example of the physical layer process processing of associated resource for a single TB. The TB or TBs on the associated resource may be processed at the physical layer at the same time.

FIG. 6B shows an example of the physical layer process processing of associated carriers for multiple TB.

FIG. 7 is a schematic diagram of the existing protocol resource grid.

FIG. 8 is a schematic diagram of multiple associated carrier frequency domain synchronous resource allocation.

FIG. 9 is an example schematic diagram of symbol-level synchronous resource allocation of multiple associated resources.

FIG. 10 shows an example of a wireless communication network.

FIG. 11 is a block diagram representation of a portion of an apparatus that can be used to implement methods and/or techniques of the presently disclosed technology.

FIG. 12A-12B show flowchart for example methods of wireless communication.

### DETAILED DESCRIPTION

Section headings are used in the present document only to improve readability and do not limit scope of the disclosed embodiments and techniques in each section to only that section.

The wireless spectrum is mainly used for communication coverage of mobile networks and is a non-renewable resource. Different countries have different radio spectrum policies, and radio spectrum planning has caused conflicts between spectrum supply and demand. Many countries around the world adopt the market-oriented auction method of spectrum, and operators purchase some frequency bands at a higher cost. In addition, due to the slow generational change, operators have to operate networks of multiple standards at the same time, facing the coexistence of 2G/3G/4G/5G for a long period of time. Most of the communication networks of different standards and different generations each occupy an independent frequency spectrum, and the occupied bandwidth is also different. With the withdrawal or phasing out of 2G and 3G networks, these spare spectrum resources also need to be re-farmed. These factors have led to the severe fragmentation of the current global spectrum resources, especially at low frequencies, it has been difficult to find continuous large-bandwidth spectrum resources. With the acceleration of 5G commercialization and the emergence of new 6G services, new scenarios, and new applications, it is necessary to support greater bandwidth and higher throughput in the future. The efficient use of fragmented spectrum will greatly alleviate the shortage of global spectrum resources.

The present document proposes, among other things, a method for associated resources configuration and association scheduling, which simplifies scheduling of associated resources, physical channel signal configuration (e.g., channel and signal configuration) and physical layer processing procedures, makes radio resource control RRC signaling lighter, and physical layer processing is parallelized to improve the system Efficiency, reduce transmission delay.

For spectrum aggregation, the traditional technology is carrier aggregation. In carrier aggregation, each carrier is an independent cell. Frequency bands which are closely-located can share similar frequency/timing information. Independent management (such as independent control signaling and broadcast messages) introduces the problems of overhead and spectrum efficiency loss (e.g., problems of increasing system overhead and reducing spectral efficiency), as well as processing procedures and time (e.g., unnecessary procedure and delay in communication). Delay increase (for example, Secondary cell SCell synchronization/addition/release/activation/measurement/mobility). As the number of carriers accommodated in a cell increases, the processing burden of the cell increases accordingly.

The present document proposes a processing method for improving system efficiency under a scenario where there are associated resources (e.g., multiple carriers), including a relationship configuration among multiple associated resources, resource mapping mode, DCI simplified processing.

For example, in one aspect, some embodiments may use the disclosed processing method for improving system efficiency under multiple resource sets, including resource set generation, batch configuration and scheduling of resource sets.

In some embodiments, a resource set may represent N associated resources, where N is a positive integer. In some embodiments, a configuration of associated resources may represent one resource set that corresponds to N associated resources, using one of 5 ways to configure associated resources: 1) An associated resource is associated with multiple carriers, that is, associated resources are formed by concatenating multiple carriers; 2) Associated resources Associate a carrier; 3) Associate resource associates a part of a carrier; 4) Associate resource associates one BWP; 5) Associate resource associates part of BWP.

In some embodiments, the number of resource blocks corresponding to the N associated resources in a resource set may be same. In some embodiments, one of the N associated resources may be selected to be a reference resource of the set. In some embodiments, mirroring configuration or scheduling may be used in which the scheduling information and/or physical channel signal configuration of the reference resource can be applied to other associated resources.

As further described with reference to various embodiments, resource sets for a wireless device may be configured by a network device via a layer 2 (L2) or a layer 3 (L3) message. Further, switching of the reference resource set may be performed through Layer 1 signaling. In various embodiments, scheduling information may be sent via L1 and/or L3.

### Embodiment 1: Use One Scheduling Message (e.g., DCI) to Dynamically Schedule Multiple Associated Resources

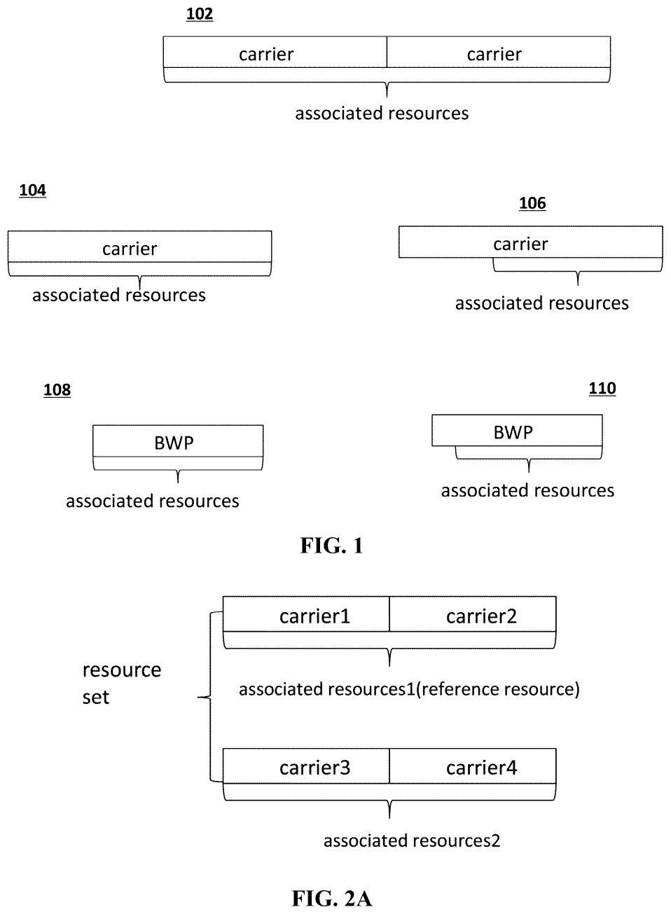

FIG. 1 is a schematic diagram of an associated resource configuration. A resource set corresponds to N associated resources, and there are 5 ways to configure the associated resources: 1) An associated resource is associated with multiple carriers, that is, the associated resource is formed by concatenating or cascading multiple carriers (102); 2) An associated resource is associated with one carrier (104); 3) The associated resource is associated with a part of a carrier (106); 4) The associated resource is associated with a bandwidth part BWP (108); 5) The associated resource is associated with a part of the BWP (110).

### Examples of Resource Set and Reference Resource Configuration

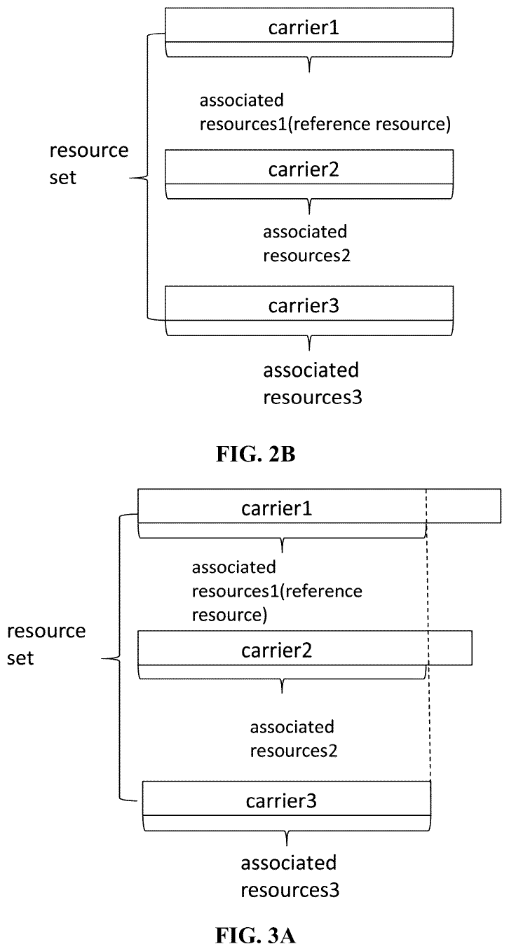

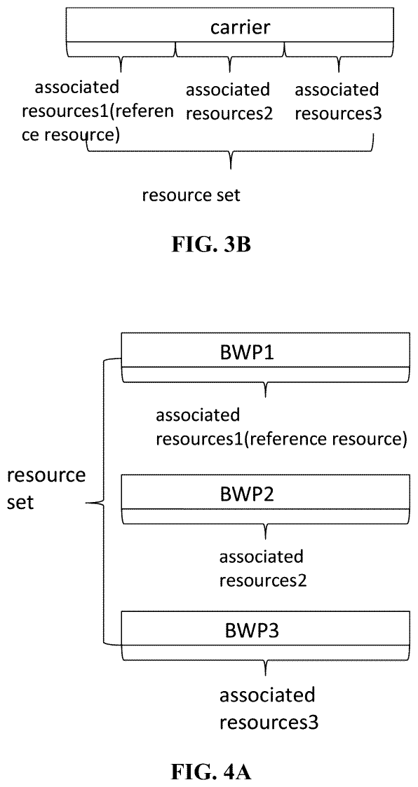

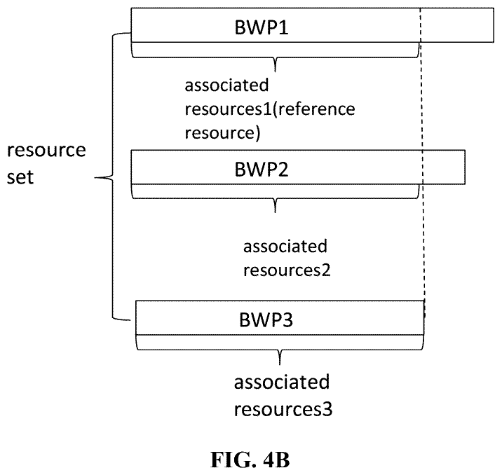

According to the above configuration principles of associated resources, a method for associated resources to form a resource set is given. As shown in FIG. 2A, an associated resource is formed by concatenating two carriers. If multiple carriers/BWPs have the same bandwidth, each carrier/BWP or PRB (physical resource block) can be directly configured as an associated resource, as shown in FIG. 2B and FIG. 4A for schematic diagrams. If multiple carriers/BWPs have different bandwidths, the same number of RBs can be mapped on the carrier/BWP as associated resources, as shown in FIG. 3A and FIG. 4B for schematic diagrams. In particular, if there is only one carrier in the cell, the carrier itself can be decomposed into multiple associated resources, as shown in FIG. 3B for a schematic diagram. After completing the configuration of the above resource set, select an associated resource in the resource set as a reference resource. Mirrored scheduling of associated resources in a resource set

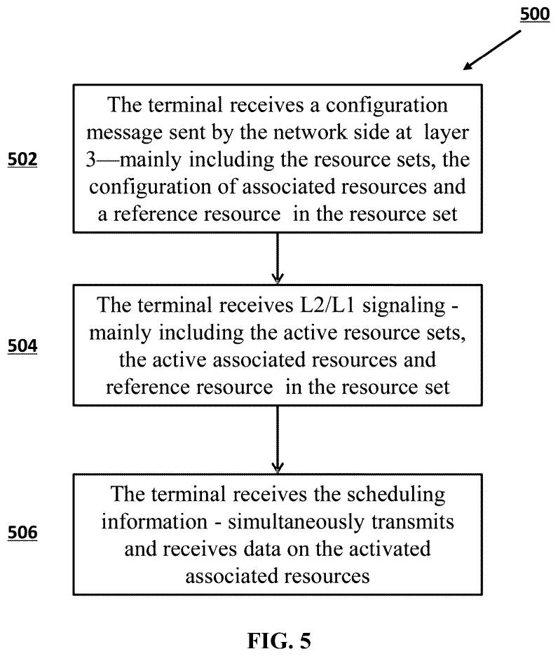

With reference to FIG. 5, one example embodiment of a wireless communication method 500 is described as below.

### Step 1: The Terminal Receives the Resource Set Configuration (502)

The terminal receives the high-level configuration sent by the network side, and the configuration includes the associated resources list (or index), the physical channel and signal configuration of the associated resource, and the associated resources (e.g., frequency domain resources) participating in the association on each reference resource. Since multiple carriers can only be associated with one set of physical channel signal configuration, high-level signaling overhead is reduced.

### Step 2: The Terminal Receives a Scheduling Message (504, Optional)

The terminal receives the high-level configuration sent by the network side, and the configuration includes the resource sets that actually participate in scheduling and M associated resources in each resource set. This step is optional, and the above information can also be carried by using L1 signaling. In some implementations, L2 signaling such as a medium access control (MAC) control element (CE) may be used.

### Step 3: The Terminal Receives the Scheduling Information (506)

The terminal receives scheduling information, e.g., the DCI information sent on the reference resource, including the indication of whether the current scheduling is mirror scheduling, and the associated resources that actually participate in the scheduling. In the case of mirror scheduling, the time-frequency domain position indicated by the DCI takes effect in each associated resource of the M resource sets. The method uses one DCI to schedule multiple associated resources at the same time, which can greatly reduce the DCI overhead, reduce the number of DCI bits, improve the physical downlink control channel PDCCH (physical downlink control channel) demodulation performance, and enhance the cell edge coverage.

When one DCI schedules multiple associated resources, each associated resource needs to have the same modulation order and number of layers.
Step 4: The Terminal Sends and/or Receives Data

The terminal simultaneously transmits or receives data at the time-frequency domain position of the resource set according to the scheduling information.

For example, if the terminal receives the DCI indication of mirror scheduling, and the frequency domain position is PRB3˜6, and the time domain position is symbol 0˜10, then the PRB3˜6 of all resource sets of the terminal, the position of the symbol 0˜10 will send data and take over.

### Embodiment 2: Scheduling Multiple Resource Sets Simultaneously Using Semi-Persistent Scheduling

In the semi-persistent scheduling scenario, one DCI schedules multiple associated carriers at the same time. Before the semi-persistent scheduling is deactivated, the multiple associated carriers take effect according to the scheduling information in the activated DCI in each transmission period.

### Embodiment 3: Parallel Physical Layer Processing

Multiple resource sets are scheduled by the same DCI, and the physical layer processes of multiple data streams can also be processed synchronously. The physical layer processes that can be processed synchronously include adding CRC, code block segmentation and adding CRC, channel coding, rate matching, Code block concatenation, scrambling, adjustment, layer mapping, multi-antenna precoding and resource mapping. The receiver and transmitter process the same, and multiple data streams can be decoded synchronously.

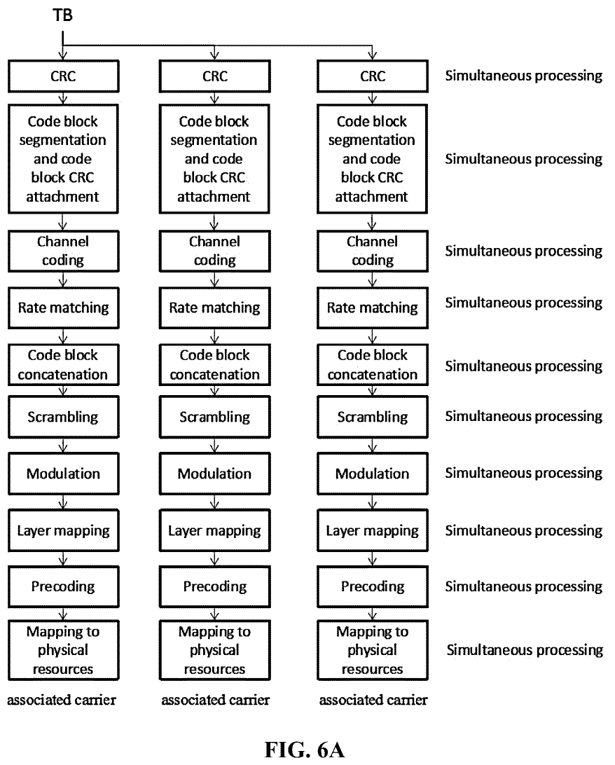

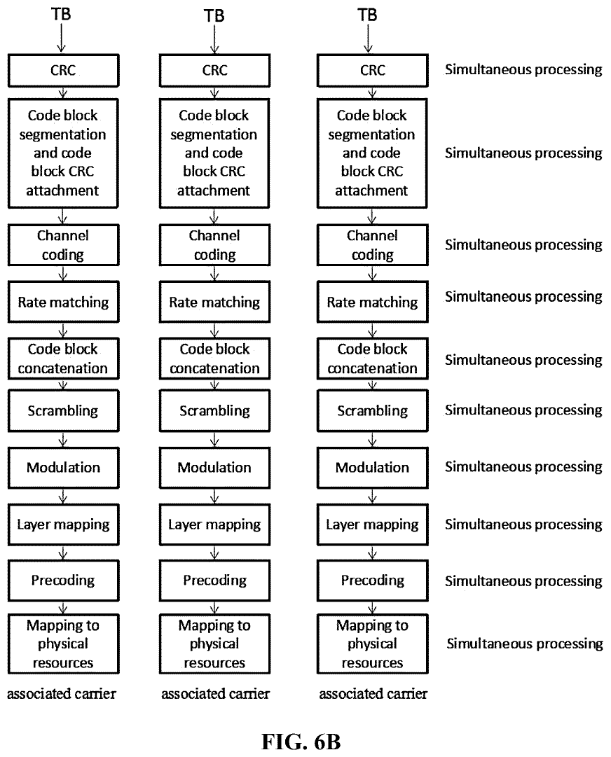

FIG. 6A shows an example of Associated Carrier Physical Layer Process Processing (Single TB)

FIG. 6B shows an example of Associated Carrier Physical Layer Process Processing (Multi-TB).

In particular, in various embodiments, two synchronization processing methods for the last step of “resource mapping” are possible.

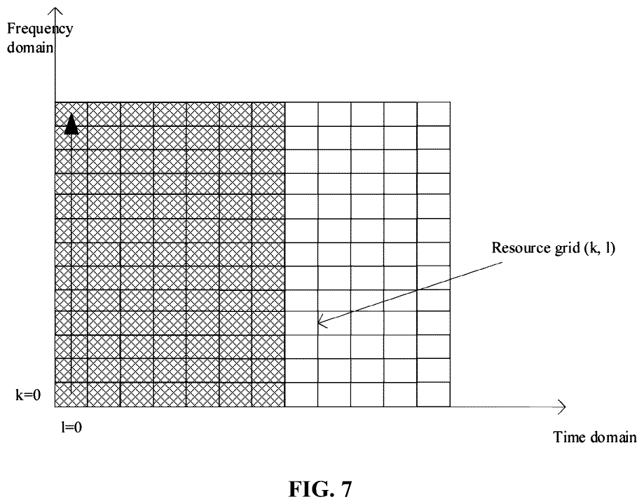

The process of mapping a complex-valued signal generated after multi-antenna precoding to a resource element (RE, Resource Element) is called resource mapping. The mapping of complex-valued signals generated by an uplink channel (e.g., physical uplink shared channel PUSCH) and a downlink channel (e.g., physical downlink shared channel PDSCH) channels to resource units (typically resource element (RE) in the resource grid) in a protocol is performed in the order of frequency domain k first, and time domain 1. FIG. 7 is a schematic diagram of the existing protocol resource grid.

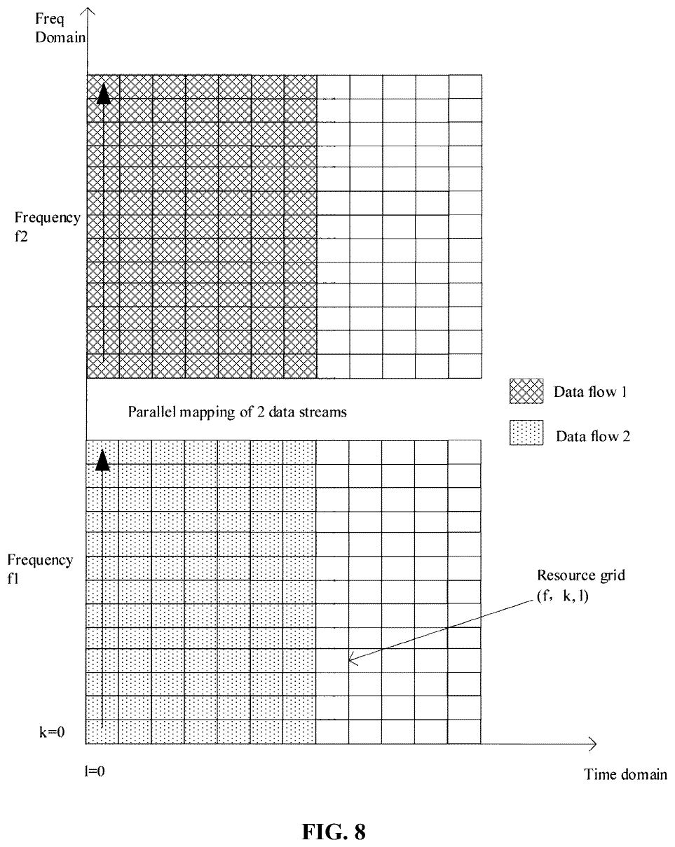

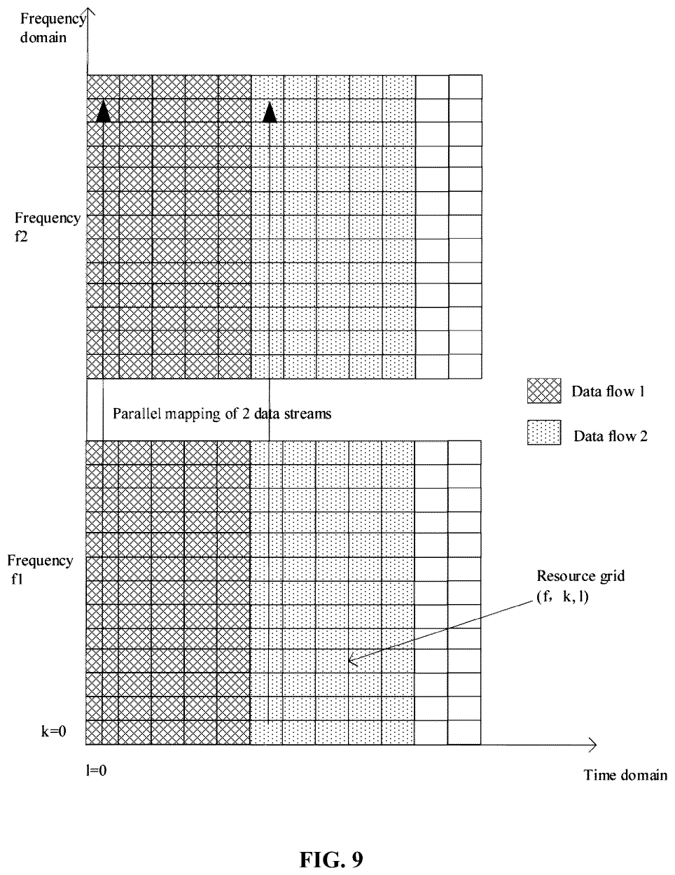

After the introduction of resource sets, the data of one user is sent on N resource sets at the same time. Therefore, the present invention increases the dimension of the frequency point f in the frequency domain k and the time domain 1. There are two ways to map multiple resource sets resource units:
Mode 1: Multiple resource sets allocate resources synchronously in the frequency domain. The schematic diagram is shown in FIG. 8.
Mode 2: Multiple resource sets are allocated resources synchronously at the symbol level. The schematic diagram is shown in FIG. 9.

Compared with existing protocols, multiple resource sets can map resources synchronously, which can significantly improve the processing efficiency of the system, thereby reducing the scheduling delay. At the same time, because the data streams are scattered on different resource sets, there is a certain frequency diversity benefit.

When data is sent in multiple resource sets, the corresponding TB number may be one or multiple. FIGS. 6A and 6B show the data flow descriptions when sending multiple TBs and the same TB, respectively.

If multiple resource sets send multiple TBs, data stream 1 is a complex-valued signal obtained by TB1 through physical layer processing, and data stream 2 is a complex-valued signal obtained by TB2 through physical layer processing.

If multiple resource sets send the same TB, the TB obtains the data stream 1 and the data stream 2 after the complex-valued signal grouping obtained by the physical layer processing.

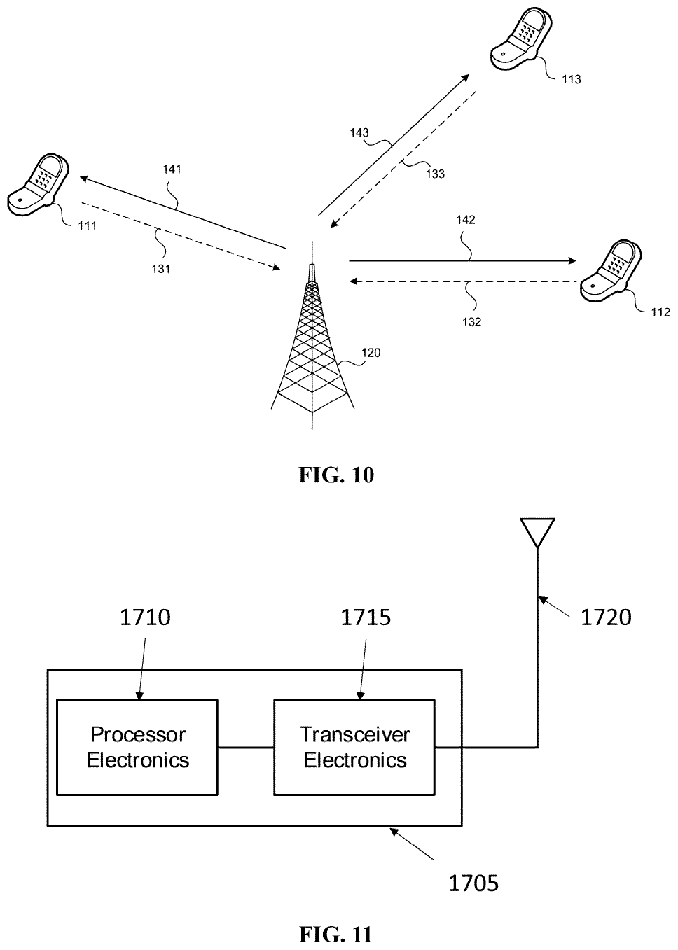

FIG. 10 shows an example of a wireless communication system (e.g., a long term evolution (LTE), 5G or NR cellular network, or next generation networks beyond 5G, such as 6th generation networks) that includes a base station (BS) 120 and one or more user equipment (UE) 111, 112 and 113. The base station, which is a network device, may be implemented on land (e.g., a cell tower) or in the air (e.g., a satellite or an aerial vehicle). In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include DCI or high layer signaling or downlink information. The UE may be, for example, a smartphone, a tablet, a mobile computer, a machine to machine (M2M) device, a terminal, a mobile device, an Internet of Things (IoT) device, and so on.

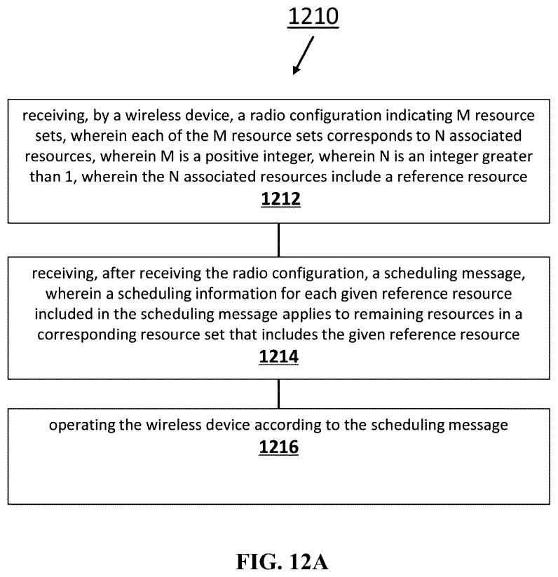

FIG. 11 is a block diagram representation of a portion of an apparatus, in accordance with some embodiments of the presently disclosed technology. An apparatus 1705 such as a network device or a base station or a wireless device (or UE), can include processor electronics 1710 such as a microprocessor that implements one or more of the techniques presented in this document. The apparatus 1705 can include transceiver electronics 1715 to send and/or receive wireless signals over one or more communication interfaces such as antenna(s) 1720. The apparatus 1705 can include other communication interfaces for transmitting and receiving data. Apparatus 1705 can include one or more memories (not explicitly shown) configured to store information such as data and/or instructions. In some implementations, the processor electronics 1710 can include at least a portion of the transceiver electronics 1715. In some embodiments, at least some of the disclosed techniques, modules or functions are implemented using the apparatus 1705.

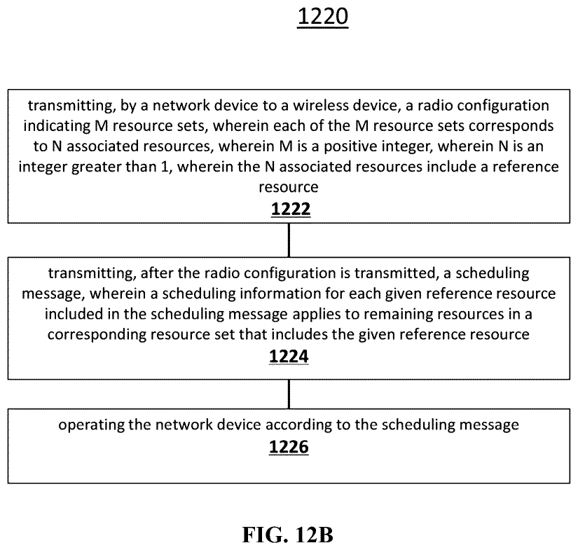

Some embodiments may preferably implement the following solutions.
1. A method of wireless communication (e.g., method 1210 depicted in FIG. 12A), comprising: receiving (1212), by a wireless device, by a wireless device, a radio configuration indicating M resource sets, wherein each of the M resource sets corresponds to N associated resources, wherein M is a positive integer, wherein N is an integer greater than 1, wherein the N associated resources include a reference resource; receiving (1214), after receiving the radio configuration, a scheduling message, wherein a scheduling information for each given reference resource included in the scheduling message applies to remaining resources in a corresponding resource set that includes the given reference resource; and operating (1216) the wireless device according to the scheduling message.
2. The method of solution 1, wherein the radio configuration is received in a message at a layer higher than a physical layer.
3. The method of any of solutions 1-2, wherein the reference resource is indicated in the radio configuration.
4. The method of any of solutions 1-3, wherein the reference resource is identified in the scheduling message.
5. The method of any of solutions 1-4, wherein the scheduling message is received at a layer below layer 3.
6. The method of any of solutions 1-5, wherein the scheduling message is a semi-persistent scheduling message.
7. The method of any of above solutions, wherein a bit size of frequency domain information in the scheduling information is based on a frequency configuration of the reference resource.
8. The method of solution 1, wherein each resources of the N associated resources is associated with a corresponding carrier.
9. The method of solution 1, wherein all resources of the N associated resources are associated with a carrier.
10. The method of solution 1, wherein resources of the N associated resources are associated with a part of a carrier.
11. The method of solution 1, wherein resources of the N associated resources are associated with a bandwidth part (BWP).
12. The method of solution 1, wherein resources of the N associated resources are parts of an associated bandwidth part (BWP).
13. The method of any of above solutions, wherein the N associated resources are associated with a single physical signal configuration.
14. The method of any of above solutions, wherein frequency domain resources of the N associated resources are from multiple carriers or multiple resources split from a single carrier.
15. The method of any of above solutions, wherein associated resources of a given resource set are configured according to one of following schemes: 1) one associated resource is associated with multiple carriers, 2) the associated resources are associated with a single carrier; 3) the associated resources are associated with a part of a carrier; 4) the associated resources are associated with a bandwidth part BWP; or 5) the associated resources are a part of an associated BWP.
16. The method of any of above solutions, wherein the operating the wireless device includes operating the wireless device according to a Semi-Persistent Scheduling, SPS, received from the radio configuration and the scheduling message.
17. The method of any of above solutions, wherein the operating the wireless device includes operating the wireless device according to an uplink grant received from the radio configuration and the scheduling message.
18. The method of any of above solutions, wherein the operating the wireless device includes transmitting or receiving data using the time-frequency resources of the N associated resources.
19. The method of any of solutions 17-18, wherein, for the transmitting or receiving data, the time-frequency resources of the N associated resources are allocated synchronously in a frequency domain.
20. The method of any of solutions 17-18, wherein, for the transmitting or receiving data, the time-frequency resources of the N associated resources are allocated synchronously at a symbol level in a time domain.
21. A method of wireless communication (e.g., method 1220 depicted in FIG. 12B), comprising: transmitting (1222), by a network device to a wireless device, a radio configuration indicating M resource sets, wherein each of the M resource sets corresponds to N associated resources, wherein M is a positive integer, wherein N is an integer greater than 1, wherein the N associated resources include a reference resource; transmitting (1224), after the radio configuration is transmitted, a scheduling message, wherein a scheduling information for each given reference resource included in the scheduling message applies to remaining resources in a corresponding resource set that includes the given reference resource; and operating (1226) the network device according to the scheduling message.
22. The method of solution 21, wherein the radio configuration is transmitted in a message at a layer higher than a physical layer.
23. The method of any of solutions 21-22, wherein the reference resource is indicated in the radio configuration.
24. The method of any of solutions 21-32, wherein the reference resource is identified in the scheduling message.
25. The method of any of solutions 21-24, wherein the scheduling message is received at a layer below layer 3.
26. The method of any of solutions 21-25, wherein the scheduling message is a semi-persistent scheduling message.
27. The method of any of solutions 21-26, wherein a bit size of frequency domain information in the scheduling information is based on a frequency configuration of the reference resource.
28. The method of solution 21, wherein each resources of the N associated resources is associated with a corresponding carrier.
29. The method of solution 21, wherein all resources of the N associated resources are associated with a carrier.
30. The method of solution 21, wherein resources of the N associated resources are associated with a part of a carrier.
31. The method of solution 21, wherein resources of the N associated resources are associated with a bandwidth part (BWP).
32. The method of solution 21, wherein resources of the N associated resources are parts of an associated bandwidth part (BWP).
33. The method of any of solutions 21-32, wherein the N associated resources are associated with a single physical signal configuration.
34. The method of any of solutions 21-33, wherein frequency domain resources of the N associated resources are from multiple carriers or multiple resources split from a single carrier.
35. The method of any of solutions 21-34, wherein associated resources of a given resource set are configured according to one of following schemes: 1) one associated resource is associated with multiple carriers, 2) the associated resources are associated with a single carrier;
3) the associated resources are associated with a part of a carrier; 4) the associated resources are associated with a bandwidth part BWP; or 5) the associated resources are a part of an associated BWP.
36. The method of any of solutions 21-35, wherein the operating the network device includes operating the network device according to a Semi-Persistent Scheduling, SPS, received from the radio configuration and the scheduling message.
37. The method of any of solutions 21-36, wherein the operating the network device includes operating the network device according to an uplink grant received from the radio configuration and the scheduling message.
38. The method of any of solutions 21-37, wherein the operating the network device includes transmitting or receiving data using the time-frequency resources of the N associated resources.
39. The method of any of solutions 27-28, wherein, for the transmitting or receiving data, the time-frequency resources of the N associated resources are allocated synchronously in a frequency domain.
40. The method of any of solutions 27-28, wherein, for the transmitting or receiving data, the time-frequency resources of the N associated resources are allocated synchronously at a symbol level in a time domain.
41. An apparatus for wireless communication comprising a processor configured to implement the method of any of the above solutions.
42. A computer readable medium having code stored thereon, the code when executed by a processor, causing the processor to implement a method recited in any of the above solutions.

In the above-described solutions and embodiments, a resource may be a grouping of transmission resources such as a carrier or a bandwidth part or a portion of a carrier or a portion of a bandwidth part. In some embodiments, the reference resource may be a primary carrier used for communication in a network.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described, and other implementations, enhancements and variations can be made based on what is described and illustrated in this disclosure.

What is claimed is:

1. A method of wireless communication, comprising:
receiving, by a wireless device, a radio configuration indicating M resource sets, wherein each of the M resource sets corresponds to N associated resources, wherein M is a positive integer, wherein N is an integer greater than 1, wherein the N associated resources include a reference resource;
receiving, after receiving the radio configuration, a scheduling message, wherein a scheduling information for each given reference resource included in the scheduling message applies to remaining resources in a corresponding resource set that includes the given reference resource; and
operating the wireless device according to the scheduling message.

2. The method of claim 1, wherein the radio configuration is received in a message at a layer higher than a physical layer.

3. The method of claim 1, wherein the reference resource is indicated in the radio configuration.

4. The method of claim 1, wherein the method further satisfies at least one of the following:
the reference resource is identified in the scheduling message;
the scheduling message is a semi-persistent scheduling message; or
a bit size of frequency domain information in the scheduling information is based on a frequency configuration of the reference resource.

5. The method of claim 1, wherein the scheduling message is received at a layer below layer 3.

6-7. (canceled)

8. The method of claim 1, wherein the N associated resources satisfy one of the following:
each resources of the N associated resources is associated with a corresponding carrier;
all resources of the N associated resources are associated with a carrier;
resources of the N associated resources are associated with a part of a carrier;
resources of the N associated resources are associated with a bandwidth part (BWP);
resources of the N associated resources are parts of an associated BWP;
the N associated resources are associated with a single physical signal configuration; or
frequency domain resources of the N associated resources are from multiple carriers or multiple resources split from a single carrier.

9-14. (canceled)

15. The method of claim 1, wherein associated resources of a given resource set are configured according to one of following schemes: 1) one associated resource is associated with multiple carriers, 2) the associated resources are associated with a single carrier; 3) the associated resources are associated with a part of a carrier; 4) the associated resources are associated with a bandwidth part BWP; or 5) the associated resources are a part of an associated BWP.

16. The method of claim 1, wherein the operating the wireless device comprises at least one of the following:
operating the wireless device according to a Semi-Persistent Scheduling, SPS, received from the radio configuration and the scheduling message;
operating the wireless device according to an uplink grant received from the radio configuration and the scheduling message; or
transmitting or receiving data using the time-frequency resources of the N associated resources.

17-18. (canceled)

19. The method of claim 16, wherein, in a case where the operating the wireless device comprises at least one of operating the wireless device according to an uplink grant received from the radio configuration and the scheduling message, or transmitting or receiving data using the time-frequency resources of the N associated resources, for the transmitting or receiving data, the time-frequency resources of the N associated resources are allocated synchronously in a frequency domain, or the time-frequency resources of the N associated resources are allocated synchronously at a symbol level in a time domain.

20. (canceled)

21. A method of wireless communication, comprising:
transmitting, by a network device to a wireless device, a radio configuration indicating M resource sets, wherein each of the M resource sets corresponds to N associated resources, wherein M is a positive integer, wherein N is an integer greater than 1, wherein the N associated resources include a reference resource;
transmitting, after the radio configuration is transmitted, a scheduling message, wherein a scheduling information for each given reference resource included in the scheduling message applies to remaining resources in a corresponding resource set that includes the given reference resource; and
operating the network device according to the scheduling message.

22. The method of claim 21, wherein the radio configuration is transmitted in a message at a layer higher than a physical layer.

23. The method of claim 21, wherein the reference resource is indicated in the radio configuration.

24. The method of claim 21, wherein the method further satisfies at least one of the following:
the reference resource is identified in the scheduling message;
the scheduling message is a semi-persistent scheduling message; or
a bit size of frequency domain information in the scheduling information is based on a frequency configuration of the reference resource.

25. The method of claim 21, wherein the scheduling message is transmitted at a layer below layer 3.

26-27. (canceled)

28. The method of claim 21, wherein the N associated resources satisfy one of the following:
each resources of the N associated resources is associated with a corresponding carrier;
all resources of the N associated resources are associated with a carrier;
resources of the N associated resources are associated with a part of a carrier;
resources of the N associated resources are associated with a bandwidth part (BWP);
resources of the N associated resources are parts of an associated BWP;
the N associated resources are associated with a single physical signal configuration; or
frequency domain resources of the N associated resources are from multiple carriers or multiple resources split from a single carrier.

29-34. (canceled)

35. The method of claim 21, wherein associated resources of a given resource set are configured according to one of following schemes: 1) one associated resource is associated with multiple carriers, 2) the associated resources are associated with a single carrier; 3) the associated resources are associated with a part of a carrier; 4) the associated resources are associated with a bandwidth part BWP; or 5) the associated resources are a part of an associated BWP.

36. The method of claim 21, wherein the operating the network device comprises at least one of the following:
operating the network device according to a Semi-Persistent Scheduling, SPS, transmitted in the radio configuration and the scheduling message;
operating the network device according to an uplink grant in the radio configuration and the scheduling message; or
transmitting or receiving data using the time-frequency resources of the N associated resources.

37-38. (canceled)

39. The method of any of claim 36, wherein, in a case where the operating the network device comprises at least one of operating the network device according to an uplink grant in the radio configuration and the scheduling message, or transmitting or receiving data using the time-frequency resources of the N associated resources, for the transmitting or receiving data, the time-frequency resources of the N associated resources are allocated synchronously in a frequency domain, or the time-frequency resources of the N associated resources are allocated synchronously at a symbol level in a time domain.

40. (canceled)

41. An apparatus for wireless communication comprising a processor configured to implement:
receiving, by a wireless device, a radio configuration indicating M resource sets, wherein each of the M resource sets corresponds to N associated resources, wherein M is a positive integer, wherein N is an integer greater than 1, wherein the N associated resources include a reference resource;
receiving, after receiving the radio configuration, a scheduling message, wherein a scheduling information for each given reference resource included in the scheduling message applies to remaining resources in a corresponding resource set that includes the given reference resource; and
operating the wireless device according to the scheduling message.

42. A non-transitory computer readable medium having code stored thereon, the code when executed by a processor, causing the processor to implement a method recited in claim 1.
